(19) United States
(12) Patent Application Publication
(10) Pub. No.: US 2024/0051417 A1
(43) Pub. Date: Feb. 15, 2024

(54) COMBINATION GENERATOR AND ALTERNATOR ARRANGEMENTS FOR USE IN DIRECT CURRENT CHARGING OF ELECTRIC VEHICLES

(71) Applicant: MayMaan Research, Inc., Hollywood, FL (US)

(72) Inventors: Yehuda Shmueli, Davie, FL (US); Eitan Shmueli, Aventura, FL (US); Doron Shmueli, Hollywood, FL (US)

(21) Appl. No.: 18/232,054

(22) Filed: Aug. 9, 2023

Related U.S. Application Data
(60) Provisional application No. 63/396,262, filed on Aug. 9, 2022.

(51) Int. Cl. B60L 53/57; H02J 7/24; H02J 7/00; B60L 53/66; B60L 58/24; B60L 53/10

(52) U.S. Cl. CPC B60L 53/57; H02J 7/24; H02J 7/00032; B60L 53/66; B60L 58/24; B60L 53/11; B60L 2210/30; B60L 2240/545

(57) ABSTRACT

Embodiments described herein are directed to a charging assembly for use with a battery. The assembly includes an engine, a voltage regulator, an engine control unit, a charging controller, and a rectifier. The engine drives an alternator for producing either of a single or multi-phase AC voltage. The voltage regulator communicates with said alternator. The rectifier converts the AC voltage from the alternator to DC prior to delivery to the battery pack. The engine operates at variable speeds during charging of the battery, including an initially higher revolutions per minute corresponding to a highest rate of charge when a current charge of the battery is at or below a predetermined threshold level, with a subsequently reduced revolutions per minute as a temperature of the battery is rising and the current charge of the battery is increasing, during which the rate of charge slows as directed by the battery management system.

### CROSS-REFERENCE TO RELATED APPLICATIONS

This utility patent application claims priority benefit from U.S. Provisional Patent Application Ser. No. 63/396,262, filed Aug. 9, 2022, and entitled “Combination Generator and Alternator Arrangement such as for use in Charging an Electric Vehicle”, the entire contents of which is incorporated herein in its entirety.

### TECHNICAL FIELD

The present disclosure relates generally to battery charging systems and assemblies. Specifically, the embodiments described herein disclose an arrangement for providing fast charging of an electric vehicle, such further having a network of rechargeable batteries.

### BACKGROUND

Electric vehicle (EV) technology has progressively advanced and is becoming the new way of personal travel as well as utilized for the commercial transporting goods. While it is a very practical solution, one of the most important challenges to widespread success and adoption involves battery capacity and charging times/rates.

Most EV type battery arrangements include any of lithium ion, nickel-metal hydride, lead-acid or ultra-capacitor type batteries, in the latter instance utilizing polarized liquids between electrodes and electrolytes to store energy and used to increase the power when the vehicle accelerates and climbs a hill, as well as assisting in regenerative braking. Ultra-capacitors also help to balance load power as a secondary energy storage system.

As is further known, the vehicle battery management system (BMS) monitors the conditions by which the EV batteries are charged and prevents either of over-charge or over-discharge conditions, such often resulting in damage of the battery, rise in temperature, reducing the life span of the battery. As is also known, an effective BMS maximizes the range of the vehicle through efficient consumption of the energy stored in it by using a different charging profiles.

A key remaining challenge is the provision of a reliable electric infrastructure and capacity for charging the EV vehicle. In particular, it is estimated that the existing electrical grid (such as often provided by coal or gas fired power plants) will need to triple or quadruple its capacity in order to support the growth rate of electric vehicle in the market.

Additionally, and while individuals and/or commercial entities have expressed the intention to purchase substantial numbers of electric vehicles, they are faced with the problem of charging capability, such as from available electricity from the grid due, the grid was built over the years and was not designed to deliver the power that is needed for the mass charging network that is needed for the mass use of EV's, where an upgrade of the grid can take years and will require a mass installation of wires substations and transformers over and underground, the availability of fast charging equipment, to very high peak usage charges. A further issue often ignored is that a grid failure can result in, among other things, shutdown of the entire transportation ability.

Referencing FIG. 1 a vehicle 1 is shown, such further having an on-board rechargeable battery source 2 (see as previously itemized) as well as an operative Battery Management System 3 (BMS). In order to reliably fast charge the vehicle 1, a high voltage DC power input (usually in the 200V to 1000V range) is needed and can include such as either of a Three Phase Generator 480V and 50/60 Hz 4 or a Power Company or power grid input source 5 (also typically 480V and 50/60 Hz) is needed.

The generated power is then delivered to a DC charging station 6, and from there supplied to the vehicle batteries 2 (via input line 7). The EV vehicle BMS 3 is in two-way communication with the DC charging station 6 (via line 8) and which enables the sensor and control software of the BMS to adjust the charge rate provided to the batteries 2.

As is further known, DC Fast Electric Vehicle Chargers EV chargers are typically classified into any of Level One, Level Two and direct current (DC) fast charging. One distinction between these three levels is the input voltage, with Level One utilizing 110/120 volts AC, Level Two utilizing 208/240 volts AC, and DC fast chargers between 200 and 600 volts AC (input).

Other known battery charging systems include such as disclosed in WO 2014/196939 and which teaches at least one electric engine converting the electric power to mechanical power. Other features include at least one alternator converting the mechanical energy produced by electric engine to electric energy, and at least one battery storing the electric energy produced by the alternator.

Other features include at least one rectifier and charger circuit rectifying the alternative current produced by the alternator and charging the battery. Also included is at least one speed sensor detecting the speed of the vehicle, with at least one electronic control unit adjusted to activate the alternator when the electric vehicle reaches a certain speed or deactivate it when the speed is lower than this certain speed.

Also disclosed is the system, apparatus and method of charging electrical vehicles set forth in U.S. Pat. No. 9,592,742 to Sosinov and which teaches an electric power supply and a power coupling element connected with the electric power supply to transfer electric energy derived from the electric power supply to an electric vehicle. Other features include a motorized cart having the electric power supply mounted thereon for movement of the electric power supply from a first location to a second location and a control and communication system connected with the motorized cart so that the electric vehicle charger can move from the first location to the second location by remote control and/or commands from the control and communication system.

Conventional supply charging stations are further known to be fairly complex and require the use of transformers or other devices to increase the voltage to the required amount, which are then rectified from AC to DC, together with capacitors to clean the output. In addition, such devices are getting constant feedback from the EV BMS 3 (battery management system) and in response adjusting the rate of charge based on sensed conditions including the EV battery temperature and other factors. As is further known, these DC fast charging units can be very costly and require permits and running the feed wires, which can amount to significant additional costs, again all of this only possible if the grid capacity if available.

Attempts at addressing this issue in order ease the grid capacity have included the use of various types of solutions that includes energy storage devices such as battery systems, flywheels, fuel cells, and internal combustion (ICE) engine-based Generators. While ICE Generators is generally found to be the most unfavorable solution, it is still the only option that can realistically provide reliable on-demand power, as an engine is turning an alternator that provides an AC 3 phase 480V to the same expensive charging station, and which requires that the ICE engine or generator run at 50/60 Hz, at which point the engine is restricted to a constant speed of 1,500/1,800 RPM. As such, most of the time the engine or generator is working outside of its efficiently “sweet spot” or “efficiency island chart”, this usually between 1,500/3,500 RPM. Furthermore, most of the engines are a polluting source of energy that are undesirable.

### SUMMARY

Addressing the above issues, disclosed herein is an improved DC fast charge arrangement for use with EV vehicles which seeks to overcome many of the disadvantages of the prior art. Any of an internal combustion engine or generator is provided which drives an alternator. The alternator is connected to a voltage regulator and operates to rectify an AC load to a DC voltage output prior to being delivered to the vehicle batteries. In alternate applications, a “DC” alternator can be employed which is able to adjust the voltage via its own regulator.

An engine control unit (ECU) is arranged in two way communication with the engine/generator, the ECU in turn being arranged in two way communication with a charging controller, which is in turn arranged in likewise two way or bi-directional communication with the vehicle BMS. A genset controller provides the processing for the generator and facilitates each of engine start-up, shutdown, data measurement, data display and fault protection functions, additional to generator power measurement, power display and power protection, with the genset controller being in communication with each of the ECU, voltage regulator, and charging controller.

Additional variants include the provision of a multiple generator unit for charging multiple vehicles. The alternator can further be revised as a three-phase unit.

Embodiments herein are also applicable to non-EV vehicle charging environments and can include any battery-operated system incorporating similar battery management system.

In one embodiment, a charging assembly for use with a battery having a battery management system is provided. The assembly includes an engine, a voltage regulator, an engine control unit, a charging controller, and a rectifier. The engine drives an alternator for producing either of a single or multi-phase AC voltage. The voltage regulator communicates with said alternator. The rectifier converts the AC voltage from the alternator to DC prior to delivery to the battery pack. The engine operates at variable speeds during charging of the battery based BMS power and charging rate request that associate with a charging profile, typically an initially higher revolutions per minute corresponding to a highest rate of charge when a current charge of the battery is at or below a predetermined threshold level, with a subsequently reduced revolutions per minute as a temperature of the battery is rising and the current charge of the battery is increasing, during which the rate of charge slows as directed by the battery management system.

In another embodiment, a charging assembly is provided. The charging assembly includes a battery assembly and a charging assembly. The battery assembly includes a battery pack having at least one battery cell. The charging assembly includes an engine, a voltage regulator, an engine control unit, a charging controller, a rectifier. The engine drives an alternator for producing a multi-phase alternating current voltage. The voltage regulator is communicatively coupled with the alternator. The engine control unit is communicatively coupled to the engine. The charging controller is communicatively coupled to the voltage regulator, the alternator, and the battery assembly. The rectifier for converting an alternating current voltage from the alternator to a direct current prior to delivery to the battery assembly. The engine operates at variable speeds during charging, including an initially higher revolutions per minute corresponding to a highest rate of charge when the battery assembly is equal to or less than a predetermined threshold, with a subsequently reduced revolutions per minute as a temperature of the battery assembly is rising and a charge level of the battery assembly is increasing or as directed by the BMS based on a charging profile.

In yet another embodiment, a charging assembly is provided. The charging assembly includes a battery assembly and a charging assembly. The battery assembly includes a battery pack having at least one battery cell. The charging assembly is positioned external to the battery assembly and includes a power conversion circuit, a processor, an engine, an engine control unit, and a charging controller.

The power conversion circuit includes a multiphase alternator, a voltage regulator communicatively coupled with the multiphase alternator, and a rectifier for converting an alternating current voltage from the multiphase alternator to a direct current prior to delivery to the battery assembly. The rectifier includes a pair of transistors for each phase of the multiphase alternator, each of the pair of transistors configured to switch between a powered on state and a powered off state to control a direction of current flow and output a controlled direct current. The processor is communicatively coupled to the power conversion circuit and configured to provide a control signal to the rectifier to switch each of the pair of transistors between the powered on state and the powered off state. The engine drives the multiphase alternator for producing a multi-phase alternating current voltage. The engine control unit is communicatively coupled to the engine and the charging controller is communicatively coupled to the power conversion circuit and to the battery assembly. The engine operates at variable speeds during charging, including an initially higher revolutions per minute corresponding to a highest rate of charge when the battery assembly is equal to or less than a predetermined threshold, with a subsequently reduced revolutions per minute as a temperature of the battery assembly is rising and a charge level of the battery assembly is increasing.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a traditional electric vehicle (EV) DC charging arrangement according to the prior art including a DC charging station supplied by either of a three phase generator or other dedicated power supply input rated at 480V AC 50/60 Hz and connected to a vehicle battery and battery management system assembly;

FIG. 2 schematically depicts an EV charging arrangement including each of a generator, alternator and supporting controllers, voltage regulators and rectifiers and which provides for adjustable rate of charge in response to such as battery rate of charge and battery temperature assembly according to one or more embodiments shown and described herein;

FIG. 3 schematically depicts a multiple alternator unit in the EV charging arrangement of FIG. 2 according to a further variant of the EV charging arrangement according to one or more embodiments shown and described herein;

FIG. 4 schematically depicts a three-phase alternator unit in the EV charging arrangement of FIG. 2 according to one or more embodiments shown and described herein;

FIG. 5 schematically depicts a topology for power conversion circuit of FIG. 4 to provide an active rectifier booster on the three phases and a buck converter that may apply a voltage to the excitation coil according to one or more embodiments shown and described herein;

and

FIG. 6 schematically depicts the three-phase alternator unit in the EV charging arrangement of FIG. 4 and including sensors and a feedback loop according to one or more embodiments shown and described herein.

### DETAILED DESCRIPTION

Embodiments described herein are directed to a charging system that is configured to operate a charging engine or generator at variable speeds to efficiently charge a battery of an electric vehicle such that, and when the battery is at or below a predetermined threshold, the rate of charge is high and, when a temperature of the battery is rising and the charge of the battery is increasing towards a predetermined “full” threshold value, the rate of charge slows. In this manner, the present system and arrangement does not require the expensive equipment capacity of conventional charging stations, and by virtue of it having a dynamic unit that adjust according to the charge rate, the overall cost effectiveness of the system is improved compared to conventional systems.

The present disclosure also addresses the need for multi-vehicle charging capability, as multiple alternators with separate coils and exciters can be coupled together, with each having its own controller and voltage regulator to address each of the BMS needs to the vehicle. In this arrangement, the engine control unit will take into account the power output needs and change the speed of the engine/generator and load to meet an efficient sweet spot for each of the individually charging EV vehicles. Generally, in a multi vehicle-charging unit, the speed of the engine will be higher in the initial part of the charge and will slow down at a later point when the consumption is lower, this enabling the fast charging of a number of vehicles connected to the same generator.

As such, the EV vehicle is charged with DC voltage that is directly connected to the generator/alternator without the need for a charging station. Further, there is a variable speed of the alternator/generator to optimize efficiency based on BMS overall power requirements in conjunction with a specific engine efficiency map. A voltage adjustment may be performed based on BMS and adjusted accordingly via controller and rectifier of the charging system. Further, current rates and/or voltage levels may be determined based on BMS and adjusted via an active rectifier of the charging system.

As used herein, the term “communicatively coupled” means that coupled components are capable of exchanging signals with one another such as, for example, electrical signals via conductive medium or a non-conductive medium, such as voltages and currents, and data signals though networks such as via Wi-Fi, Bluetooth, conductive mediums or a non-conductive mediums, and the like, and electromagnetic signals via air, optical signals via optical waveguides, conductive mediums or a non-conductive mediums, and the like.

With reference to the attached illustrations, including the schematic of FIG. 2, the present disclosure discloses a charging arrangement, generally at 10 in FIG. 2, for fast charging a battery supported vehicle or appliance, such as, without limitation, an electric type vehicle 1, further again including an arrangement of batteries 2 and corresponding management system and BMS 3. The batteries 2 may be a battery assembly that includes at least one battery cell that is configured to be rechargeable. The batteries 2 may be configured to provide propulsion to the vehicle 1 and/or provide electrical power to other components of the vehicle 1 or to other appliances.

As previously described, the features of the EV charging arrangement 10 includes an engine or generator 12, such as which can include any of the internal combustion variety and which can operate off of any fuel source not limited to various grades of gas, diesel, natural gas, propane, hydrogen, water, electric, and/or the like. Further, it should be understood that the EV charging arrangement 10 is releasably coupled to the vehicle 1 or other appliances through connectors which are known by those skilled in the art.

An alternator 14 is provided which is driven by the engine 12 via connection 16. As is generally known, the alternator 14 is an electrical generator that converts mechanical energy to electrical in the form of alternating current. As is further known, an alternator uses a permanent magnet for its magnetic field, which is called a magneto.

The alternator 14 is communicatively coupled to a voltage regulator 18 and operates to rectify an AC load to a DC voltage output prior to being delivered to the battery assembly 2. This occurs through each of a stator field 20 and rotor field 22 represented within the alternator 14 which interfaces with the voltage regulator 18 and operates to supply the AC output to a rectifier component 24 for conversion to DC which is then transmitted via an output line 26 to the EV batteries 2 of the vehicle 1. As such, it should be appreciated that the rectifier component 24 is communicatively coupled to the EV batteries 2 of the vehicle 1 via the output line 26. Without limitation, the alternator 14 depicted can be substituted by a “DC” version alternator which is able to adjust the voltage via its own internal regulator. As such, the EV vehicle 1 is charged directly with DC output voltage generated by the charging arrangement 10 (e.g., an AC load produced by the alternator 14 and converted by the by the rectifier 24/voltage regulator 18) without the need for a charging station.

An engine control unit 28 is arranged in two-way or bi-directionally communicatively coupled for communication with the engine/generator 12 via communication line 30. The ECU 28 in turn may also be arranged in two-way or bi-directionally communicatively coupled for communication with a charging controller 32 via communication line 34, which is in turn arranged in likewise two way or bi-directionally communicatively coupled for communication via a communication line 36 with the vehicle BMS 3.

The engine control unit 28 be an electronic control unit (ECU), a central processing unit (CPU), and/or the like, for performing the functions as described herein. For example, the engine control unit 28 may be configured to receive, analyze and process sensor data and/or image data, perform calculations and mathematical functions, convert data, fuse data, or information, control the engine/generator 12, and the like. The engine control unit 28 may include one or more processors, and other components, for example one or more memory modules that stores logic that is executable by the one or more processors. Each of the one or more processors may be a controller, an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors.

Also depicted is communication line 37 communicatively coupled to and extending between the BMS 3 and a voltage regulator 18, which is a device, used in generators to automatically regulate a voltage level by smoothing out any fluctuations in voltage into a constant level. That is, the voltage regulator 18 may filter or smooth the sine/cosine waves into a repeatedly constant level. The communication line 37 permits the voltage regulator 18 to adjust the voltage to in turn determine the rate of charge based on specification of the BMS 3 of the vehicle 1.

A genset controller 38 provides the operations for the generator 12 and alternator 14, and facilitates each of engine start-up, shutdown, data measurement, data display and fault protection functions, additional to generator power measurement, power display and power protection, is provided to be communicatively coupled with each of the ECU 28 via communication line 40, the voltage regulator 18 via communication line 42, and charging controller 32 via the communication line 44). Also depicted is communication line 45 established between and to communicatively couple the genset controller 38 and charging controller 32.

The genset controller 38 may be an electronic control unit (ECU), a central processing unit (CPU), and/or the like, for performing the functions as described herein. For example, the ECU may be configured to receive, analyze and process data, perform calculations and mathematical functions, convert data, generate data, control various charging components, and the like. The genset controller 38 may include one or more processors, and other components, for example one or more memory modules that stores logic that is executable by the one or more processors. Each of the one or more processors may be a controller, an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors. The computer-executable instructions may include logic or algorithms, written in any programming language of any generation such as, for example machine language that may be directly executed by the processors, or assembly language, object orientated programming, scripting languages, microcode, etc., that may be compiled or assembled into computer-executable instructions and storage on the one or more memory modules. Alternatively, the computer-executable instructions may be written in hardware description language, such as logic implemented via either a field programmable gate array (FPGA) configuration or an application specific integrated circuit (ASIC), all their equivalents. Accordingly, the methods and/or processes described herein may be implemented in any conventional computer programming language, as preprogrammed hardware elements, or as a combination of hardware and software components.

The genset controller 38 may further include the necessary components, software, firmware, hardware, and the like to be communicatively coupled to the BMS 3 such that data may transfer between the devices in a bi-directional manner. The BMS 3 may transmit s plurality of battery related data such as data related to a current charge of the battery assembly 2, an overall power requirement of the battery assembly 2, an engine efficiency map of the vehicle 1, a temperature of the battery assembly 2, and other data that may be sensed or saved on the vehicle and communicated via the BMS 3. As such, the genset controller 38 may receive the plurality of battery related data transmitted from the BMS 3. In response, the genset controller 38 may provide commands or instructions to other components of the EV charging arrangement 10 to vary or change engine operating speeds during charging of the battery assembly 2 based on the plurality of battery related data transmitted from the BMS 3 to vary the direct current voltage output to the battery assembly 2. Varying such engine operating speeds during charging optimize charging efficiency based on BMS 3 determined overall power requirements and with specific engine efficiency map of the vehicle 1. As such, specific voltage adjustments may be made based on the data from the BMS 3 and performed by the genset controller 38 and the rectifier 24.

As described, the alternator-generated voltage (such as 200V to 1000V AC) is provided in either of single or three phase fashion. However, this is nonlimiting and the phases may be more than three, such as five, seven, nine, and the like. The generator 12 speed (or RPM) can be adjusted by the genset controller 18 over the course of the EV charging cycle, which is further in real time communication with the BMS 3, such as to adjust (typically lower) the RPM of the generator 12 in response to look up table variables associated with optimal charging rates of the battery 2, as determined by the BMS 3, and taking into account such factors as the battery temperature and current charge level and in order to achieve an efficiency sweet spot.

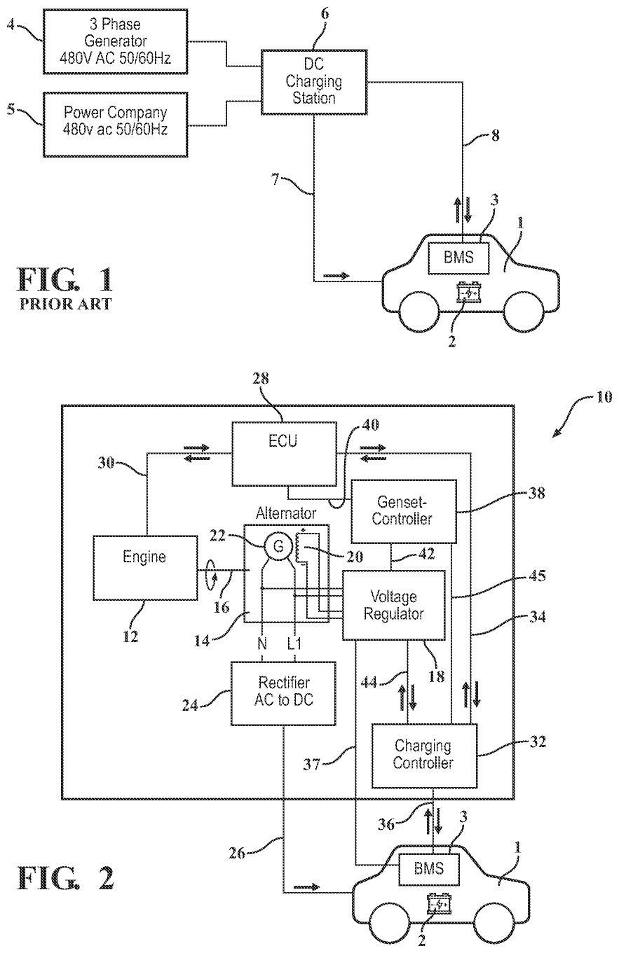

This engine type or any other engine that make a kinetic power is coupled with an alternator, the alternator will be capable of producing 200 to 1000V AC single phase (based on a voltage regulator that excite it accordingly), the AC is rectified to DC, again at 24, with additional power conditioners and will be connected directly the vehicle, eliminating completely the need for expensive charging station units, such as described in FIG. 1 and the other referenced prior art.

The BMS 3 will further communicate directly with a control panel (not shown) which will automatically control the voltage regulator to address the output needs and charging rate of the vehicle batteries 2 (including each type as previously defined and not limited to lithium ion type cells).

As also previously described, the speed of the engine/generator 12 will not be restricted to 1,500 or 1,800 rpm, as the unit will provide DC power to the vehicle, thereby achieving the “Efficiency Island sweet spots” through maximization of the potential of the unit.

As is further known, power output of the engine 12 is a function of torque and RPM, with any restriction of RPM limiting the maximum output of the unit. By non-limiting example, an engine with a displacement of 6.2 liter that is turning at 1800 rpm and produces 390 lb. of torque, will output about 100 Kw, with the same engine if running at 3000 rpm producing the same 3901b of torque will output about 166 Kw, translating to an extra 40% more power output.

By way of further description, the engine control unit 28, also commonly referred to as an engine control module (ECM), is a type of electronic control unit that controls a series of actuators on the internal combustion engine 12 to ensure optimal engine performance. It does this by reading values from a multitude of sensors within the engine bay, interpreting the data using multidimensional performance maps (called lookup tables), and adjusting the engine actuators.

In this manner, the advantage of the charging engine or generator 12 operating at variable speeds is crucial for its ability to efficiently charge the EV vehicle 1 such that, and when the battery 2 is equal to and/or below a predetermined threshold value (e.g., nearly empty, empty, or in a depleted state), the rate of charge is high and, when a temperature of the battery 2, sensed by the BMS 3 is rising and a charge level of the battery 2 is increasing towards a predetermined fully charged “full” threshold value, the rate of charge slows significantly. In this manner, the present system and arrangement does not take require the expensive equipment capacity of prior art charging stations, and by virtue of it having a dynamic unit that adjust according to the charge rate, the overall cost effectiveness of the system is better.

The present disclosure also addresses the need for multi-vehicle charging capability, as multiple alternators with separate coils and exciters can be coupled together, with each having its own controller and voltage regulator to address each of the vehicle's BMS needs. In this arrangement, the engine control unit will take into account the power output needs and change the speed of the engine/generator 12 and load to meet an efficient sweet spot for each of the individually charging EV vehicles. Generally, in a multi vehicle charging unit, the speed of the engine 12 will be higher in the initial part of the charge and will slow down at a later point when the consumption is lower, this enabling the fast charging of a number of vehicles connected to the same generator.

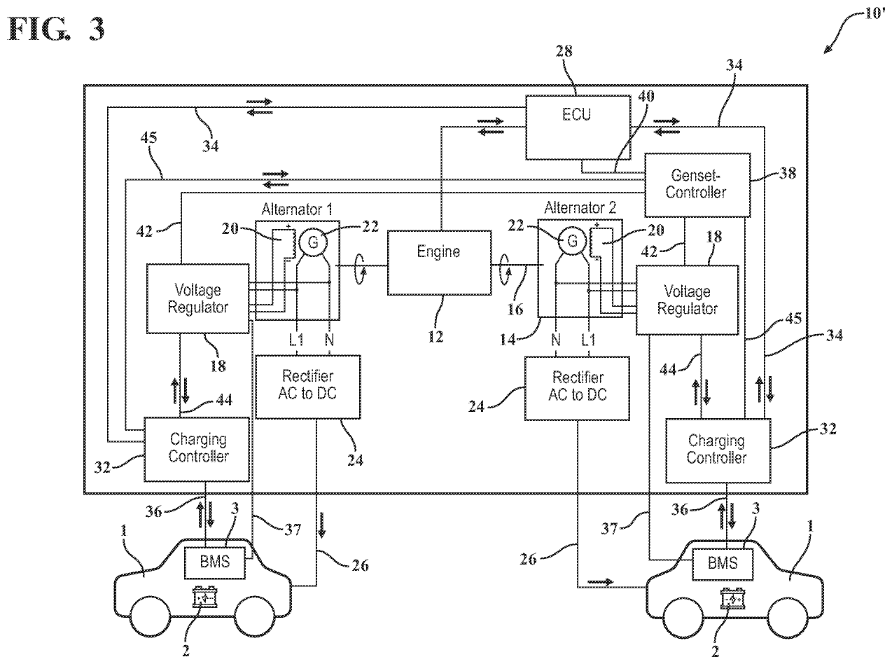

Referring to FIG. 3, an illustration is generally shown at 10′ of a multiple alternator unit based on the teachings of FIG. 2 according to a further variant of the EV charging arrangement. Identical components are repetitively numbered with reference made to the descriptions provided in FIG. 2. In this fashion, multiple alternator units can be operated off a single engine/generator in order to provide enhanced fast charge capabilities for more multiple BMS operated battery powered devices (again including but not limited to EV vehicles).

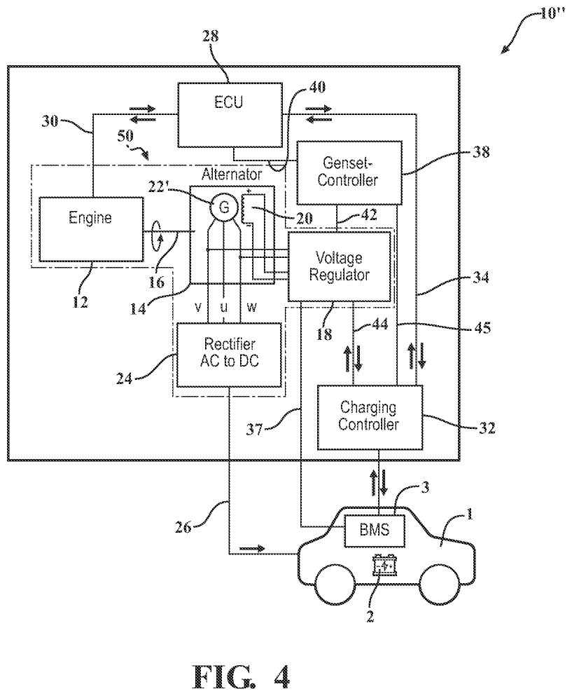

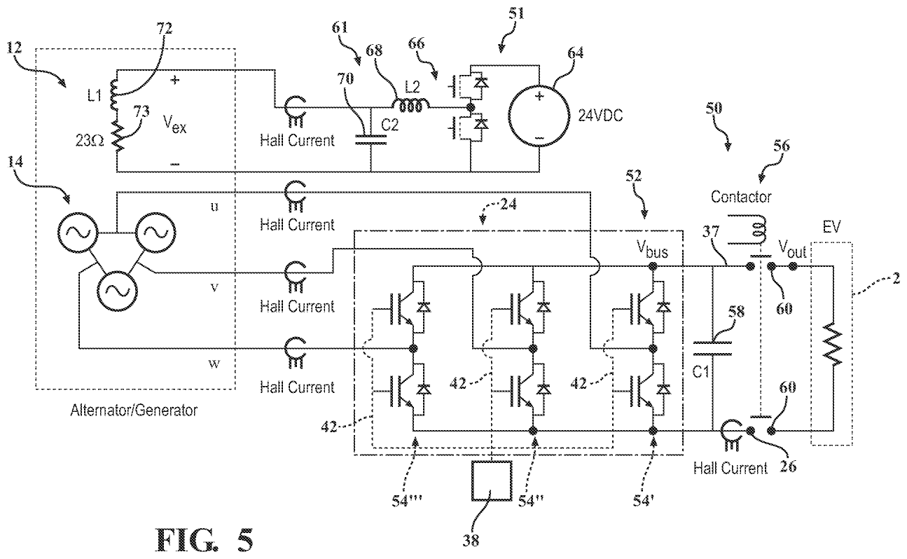

Referring now to FIG. 4, a charging arrangement 10″ according to a further variant and which incorporates a multiphase alternator unit, further shown at 22′. As illustrated, the multiphase alternator 22′ includes three single-phase windings spaced such that the voltage induced in any one phase is displaced by one hundred and twenty degrees from the other two. As such, the multiphase alternator 22′ is depicted as a three-phase alternator. It should be understood that this is non-limiting and the multiphase alternator unit 22′ may be any number of phases, such as five phase, seven phase, nine phase, and the like. Otherwise, the charging arrangement of FIG. 4 is as substantially previously described.

Now referring to FIG. 5, which schematically depicts a topology for power conversion circuit 50 that includes the engine/generator 12, the alternator 14, the voltage regulator 18, and the rectifier 24 of FIG. 4, to provide an active rectifier booster on the three phases and a buck converter that may apply a voltage 0-24V to the excitation coil 51. As such, it is understood that the power conversion circuit 50 is communicatively coupled to and/or utilizes the components of FIG. 4 with the exceptions of the features described herein and, as such, for brevity reasons, these features will not be described again.

In a non-limiting example, the engine/generator 12 may be a 480 V AC, 60 Hertz synchronous machine with the exciter coil 51, separated from the engine/generator 12 driven at a nominal 12V DC. Further, the windings and exciters of the generator 12 may be electrically isolated with at least a 2 MΩ to chassis. Further, the vehicle 1 may be targeting a 500 V DC system with a plus/minus of 5 percent, which may correspond to a 250 kW charge, as a load. As such, this may be greater than the engine/generator 12. As such, the arrangement of the present disclosure provides efficiency, flexibility and controllability. As such, the alternator 14 may include an exciter field from 0V-24V DC and at 18-23.9Ω. The windings may be configurable with 277 V AC in series delta connection and operate at 40-80 Hz. Further, the load may be between 0 to 500 V DC at 500 A DC. It should be apparent to those skilled in the art that the arrangement in the alternator 14, including the windings and/or exciter field may be other ranges, be arranged in different configurations, and configurable with different voltages without limitation.

The excitation coil 51 may include a 0V-24V direct current power source 64, the buck converter 61 that includes a capacitor 70 and an inductor 68 and a pair of MOSFETs 66 arranged such that at least one of the pair of MOSFETs 66 is in a parallel arrangement with the capacitor 70. Further, the generator 12 includes an inductor 72 and a resistor 73 in a series arrangement and the inductor 72 and the resistor 73 are arranged in a parallel arrangement with the capacitor 70 and the pair of MOSFETs 66.

The power conversion circuit 50 is communicatively coupled to the genset controller 28 and the charging controller 32 via communication line 42 and/or communication lines 34, 44, 45. As such, in this embodiment, the rectifier booster 24, depicted as a plurality of transistors 52, are configured to switch between a powered on state and a powered off state, based on a control signal received from the genset controller 28. Such control allows the active rectifier to control the direction of current flow in the coils, which in turn allows it to produce a more efficient and controlled direct current output. As such, as described in detail herein, the genset controller 28 and/or the charging controller 32 provide the control signal to the transistors 52 to switch between the powered off and powered on states. As such, the rectifier booster 24 may be known as active transistors and may use the coils of the alternator 14 by replacing the traditional diodes with power transistors. Such control allows the active rectifier to control the direction of current flow in the coils, which in turn allows it to produce a more efficient and controlled DC output.

In some embodiments, the transistors 52 may be insulated-gate bipolar transistor (IGBT). In other embodiments, the transistors may be any semiconductor device. In other embodiments, MOSFETs may be used and may be controlled between a powered on state and a powered off state by the control signal. Further, it should be appreciated that in some embodiments, MOSFETs may be used in conjunction or combination with IGBTs.

Each of the transistors 52 are separated into pairs of transistors 54′, 54″, 54′″ and each of the pairs transistors 54′, 54″, 54′″ are positioned in a parallel arrangement. Further, because the alternator 14 is a multiphase alternator, each phase of the alternator 14 is communicatively coupled to respective pair of transistors of the pair of transistors 54′, 54″, 54′″ such that the output from each respective phase of the alternator 14 may be controlled to be smoothed or filtered of the sine wave when compared to conventional systems. This arrangement results in a controlled and efficient direct current output from the rectifier 24 by using the transistors 52 to control a direction of current flow and output the controlled direct current. As such, the power conversion circuit 50 is configured to convert the alternating current voltage from the alternator 14 to the direct current prior to delivery to battery assembly 2 and to control a direction of current flow and output a controlled direct current.

The genset controller 28 and/or the charging controller 32 is configured to actively control via at least one control signal and/or data transmitted from the genset controller 28 and/or the charging controller 32 to the transistors 52. This is advantageous compared to the conventional systems where the rectifier booster is passive for the reasons further discussed herein. The power conversion circuit 50 described herein provides may advantages from conventional passive systems such as a more simple, or less complicated using less components design, there are not large magnetic passives, the output voltage is controllable and may be anything at or above the alternator output voltage, the field excitation voltage is fully controllable, changing the motor constant, the current of the generator 12 and the output are measured for use in controls and limits, a contactor may allow mechanical, complete output disconnection, and the use of transistors instead of diodes allows custom communication that boosts voltage and operates in efficient regimes.

In a conventional alternator, the diodes in the rectifier assembly simply pass current in one direction, regardless of the polarity of the AC input. Such an arrangement leads to problems such as voltage spikes and ripple, which may damage the electrical system of the vehicle 1. The power conversion circuit 50 described herein with the active rectifiers, on the other hand, control the direction of current flow, which allows a production of a much cleaner and more regulated direct current output.

In addition to providing a cleaner direct current output, the power conversion circuit 50 described herein with active rectifiers improve the efficiency of the alternator 14 because the diodes in a traditional rectifier assembly have a voltage drop, which means that some of the energy from the alternator is lost as heat while the active rectifiers of the power conversion circuit 50, on the other hand, have a much lower voltage drop, which means that more of the alternator's output is converted into usable direct current power. As such, each phase (coils) of the alternator 14 are used by the transistors 52 (active rectifier) to generate the alternate current input current. The coils are arranged in three or more phases, and the active rectifier uses a switching circuit to control the current flow through each phase, which permits for the active rectifier to produce a more efficient and controlled direct current output.

Further, the power conversion circuit 50 may include a contactor 56 to prevent undesirable results such as short circuits, overloads, unwanted influx of current or voltage, and the like.

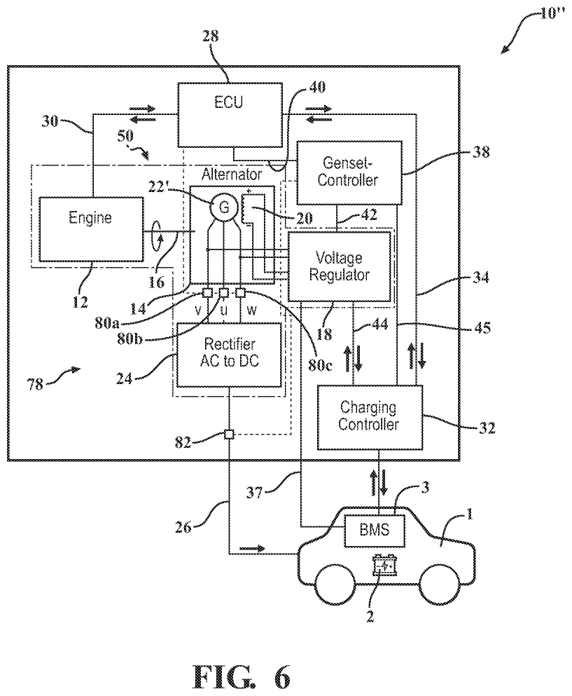

Now referring to FIGS. 5 and 6, in some embodiments, the output voltage from the alternator exciter 51 may be regulated using the rectifier 24 with a feedback loop 78 to control the DC output voltage via communication line 26. The feedback loop 78 may be configured to compare the actual output voltage via DC current sensor 82, and current sensors 80a, 80b, 80c to a desired output voltage that is determined by the BMS 3 and stored or calculated by the genset controller 38. In response, the genset controller 38 may adjust a duty cycle of the switch (e.g., different transistors 52) to maintain the desired output voltage. The duty cycle may be a percentage of time that the switch (e.g., different transistors 52) is in a powered on state. A higher duty cycle may result in a higher output voltage, and a lower duty cycle may result in a lower output voltage. As such, the feedback loop is smart in that it automatically adjusts the duty cycle so that the output voltage is always maintained at a desirable level.

As such, the current sensors 80a, 80b, 80c are communicatively coupled to the output of the alternator 14 and are communicatively coupled to the ECU 28. The DC current sensor 82 is communicatively coupled to the communication line 26 and to genset controller 38 such that feedback loop 78 may be configured to regulate the output DC voltage in view of the requirements required by the BMS 3 and the actual and desired outputs by the charging arrangement 10 such as the charge rate, voltage, and current.

Further, the feedback loop 78 may allow the rectifier 24 to be active to regulate the output voltage precisely. Such an arrangement is advantageous in cases where constant charging is required such as where the output voltage needs to be kept constant, such as in power supplies and battery chargers.

Further, in other aspects of current regulation using the information from the BMS 3, the rectifier 24 may control the current as well by using the feedback loop 78 to control the duty cycle of the switch (e.g., different transistors 52). The feedback loop 78 may provide data such that the genset controller 38 may compare the actual current to the desired current and then adjusts the duty cycle of the switch (e.g., different transistors 52) to maintain the desired current. As such, the duty cycle is the percentage of time that the switch (e.g., different transistors 52) is turned on. A higher duty cycle may result in a higher current, and a lower duty cycle may result in a lower current. As such, the feedback loop adjusts the duty cycle so that the current is always maintained at the desirable level.

Beyond the variants described, the present EV charging arrangement again is understood to not be limited to EV type fast charging and can envision the ability to charge any battery containing equipment or appliance including a similar battery management system. This can further include without limitation such as battery pack powered telecommunication towers which include a similar battery management system operated by a generator and which is subject to the same restriction issues as to specific RPM's. The charging arrangement of the present disclosure also provides for off-grid charging of any BMS operated battery pack and which can be used to shave peak demand from the grid during high usage times.

Having described my innovation, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

What is claimed is:

1. A charging assembly for use with a battery having a battery management system, the charging assembly comprising:
an engine driving an alternator for producing either of a single or multi-phase AC voltage;
a voltage regulator communicating with said alternator; and
a rectifier for converting the alternating current voltage from the alternator to direct current voltage output prior to delivery to the battery; and
a processor communicatively coupled to the battery management system, the processor configured to receive a plurality of battery related data transmitted from the battery management system,
wherein the battery is directly communicatively coupled to the alternator, the engine operating at variable speeds during charging of the battery based on the plurality of battery related data transmitted from the battery management system to vary the direct current voltage output to the battery.

2. The charging assembly of claim 1, wherein the engine operating at variable speeds during charging of the battery based on the plurality of battery related data transmitted from the battery management system, including an initially higher revolutions per minute corresponding to a highest rate of charge when a current charge of the battery is at or below a predetermined threshold level, with a subsequently reduced revolutions per minute as a temperature of the battery is rising and the current charge of the battery is increasing, during which the rate of charge slows as directed by the battery management system.

3. The charging assembly of claim 1, wherein the plurality of battery related data includes an overall power requirement and an engine efficiency map.

4. The charging assembly of claim 1, further wherein the voltage regulator operating in combination with the rectifier converts the alternating current voltage to the direct current voltage output prior to being delivered to the battery, the alternator having each of a stator field and rotor field represented which interfaces with the voltage regulator and operates to supply the alternating current voltage to the rectifier for conversion to the direct current voltage output, which is then transmitted via a connecting line to the battery.

5. The charging assembly of claim 1, wherein the processor further comprises:
facilitating each of an engine start-up, a shutdown, a data measurement, a data display and a fault protection functions, additional to generator power measurement, a power display and a power protection, and
the processor communicatively coupled with each of an engine control unit, the voltage regulator and a charging controller.

6. The charging assembly of claim 1, further comprising the battery and the battery management system are incorporated into an EV type vehicle.

7. The charging assembly of claim 1, wherein said alternator further comprising multiple alternators for charging multiple batteries.

8. The charging assembly of claim 1, wherein said alternator further comprising a three phase output.

9. A charging system comprising:
a battery assembly including:
a battery pack having at least one battery cell; and
a battery management system,
a charging assembly releasably communicatively coupled including:
an engine driving a multiphase alternator for producing an alternating current voltage;
an engine control unit communicatively coupled to the engine;
a voltage regulator communicatively coupled with the alternator; and
a rectifier for converting the alternating current voltage from the multiphase alternator to a direct current voltage output prior to delivery to the battery assembly,
a processor communicatively coupled to the battery management system, the processor configured to receive a plurality of battery related data transmitted from the battery management system,
wherein the battery assembly is directly communicatively coupled to the alternator, the engine operating at variable speeds during charging of the battery assembly based on the plurality of battery related data transmitted from the battery management system to vary the direct current voltage output to the battery assembly.

10. The charging system of claim 9, wherein the engine control unit operates the engine at variable speeds during charging based on the plurality of battery related data transmitted from the battery management system, including an initially higher revolutions per minute corresponding to a highest rate of charge when the battery assembly is equal to or less than a predetermined threshold, with a subsequently reduced revolutions per minute as a temperature of the battery assembly is rising and a charge level of the battery assembly is increasing.

11. The charging system of claim 9, wherein the voltage regulator operating in combination with the rectifier configured to rectify the alternating current voltage to the direct current voltage output prior to being delivered to the battery assembly, the multiphase alternator having each of a stator field and rotor field represented which interfaces with the voltage regulator and operates to supply the alternating current voltage to the rectifier for conversion to the direct current voltage output which is then transmitted via a connecting line to the battery assembly.

12. The charging system of claim 9, wherein:
the processor facilitating each of an engine start-up, a shutdown, a data measurement, a data display and a fault protection functions, additional to generator power measurement, a power display and a power protection, the processor communicatively coupled with each of the engine control unit, the voltage regulator and the charging controller.

13. The charging system of claim 9, wherein the battery assembly is incorporated into an EV type vehicle.

14. The charging system of claim 9, wherein said multiphase alternator further comprising multiple multiphase alternators for charging multiple battery assemblies.

15. A charging system comprising:
a battery assembly including:
a battery pack having at least one battery cell; and
a battery management system,
a charging assembly releasably communicatively coupled to the battery assembly, the charging assembly including:
a power conversion circuit having:
a multiphase alternator;
a voltage regulator communicatively coupled with the multiphase alternator; and
a rectifier for converting an alternating current voltage from the multiphase alternator to a direct current voltage output prior to delivery to the battery assembly, the rectifier including a pair of transistors for each phase of the multiphase alternator, each of the pair of transistors configured to switch between a powered on state and a powered off state to control a direction of current flow and output a controlled direct current;
a processor communicatively coupled to the power conversion circuit and to the battery management system, the processor configured to receive a plurality of battery related data transmitted from the battery management system, the processor configured to provide a control signal to the rectifier to switch each of the pair of transistors between the powered on state and the powered off state based at least partially on the plurality of battery related data transmitted from the battery management system;
an engine driving the alternator for producing a multi-phase alternating current voltage; and
wherein the battery assembly is directly communicatively coupled to the alternator, the engine operating at variable speeds during charging of the battery assembly based at least partially on the plurality of battery related data transmitted from the battery management system to vary the direct current voltage output to the battery assembly.

16. The charging system of claim 15, further comprising:
an engine control unit communicatively coupled to the engine,
wherein the engine control unit operates the engine at variable speeds during charging, including an initially higher revolutions per minute corresponding to a highest rate of charge when the battery assembly is equal to or less than a predetermined threshold, with a subsequently reduced revolutions per minute as a temperature of the battery assembly is rising and a charge level of the battery assembly is increasing.

17. The charging system of claim 15, wherein each transistor of the pair of transistors coupled to each phase of the multiphase alternator are insulated-gate bipolar transistors.

18. The charging system of claim 15, wherein the power conversion circuit is configured to rectify the multi-phase alternating current voltage to the direct current voltage output prior to being delivered to the battery assembly, which is then transmitted via a connecting line to the battery assembly.

19. The charging system of claim 15, wherein the processor is further configured to:
facilitate each of an engine start-up, a shutdown, a data measurement, a data display and fault protection functions, additional to a generator power measurement, a power display and a power protection.

20. The charging system of claim 15, wherein the battery assembly is incorporated into an EV type vehicle.
